(19) United States
(12) Patent Application Publication
(10) Pub. No.: US 2016/0140269 A1
(43) Pub. Date: May 19, 2016

(54) STRUCTURAL TOPOLOGY OPTIMIZATION DESIGN METHOD

(71) Applicant: INDUSTRIAL TECHNOLOGY RESEARCH INSTITUTE, Hsinchu (TW)

(72) Inventors: Chia-Pei Wang, Tainan City (TW); Chien-Chih Liao, Taichung City (TW); Pei-Yin Chen, Taichung City (TW); Tzuo-Liang Luo, Taichung City (TW)

(21) Appl. No.: 14/583,471

(22) Filed: Dec. 26, 2014

(30) Foreign Application Priority Data
Nov. 14, 2014 (TW) 103139488

(51) Int. Cl. G06F 17/50

(52) U.S. Cl. CPC G06F 17/5018

(57) ABSTRACT

A structural topology optimization design method is provided. A structural topology optimization question is defined to determine at least one set of load and restriction condition and a parameter of lower limit of volume capacity related to a design space model. This model is divided into mesh grids for performing finite element analysis (FEA). Strain energy of each element after FEA is obtained according to the established load and restriction condition and used as a basis for calculating sensitivity of each element. A part of elements is removed or retained according to the degree of sensitivity of each element, and the structural profile and the total volume capacity and total strain energy of residual elements of the structural profile are recorded after each loop was completed. A display interface is used to sequentially show the structural profile and a relationship diagram of structural volume capacity vs structural strain energy.

This application claims the benefit of Taiwan application Sequential No. 103139488, filed Nov. 14, 2014, the disclosure of which is incorporated by reference herein in its entirety.

### TECHNICAL FIELD

The disclosure relates in general to a structural topology optimization design method, and more particularly to a structural topology optimization design method conformed to processing feasibility.

### BACKGROUND

In general, structural topology optimization is for optimizing the distribution of material to find an optimal solution from a design space with uniform distribution of material. Currently, the structural topology optimization technology, which considers detailed design and various processing feasibilities, cannot generate a once for designing optimization structure. Therefore, in engineering practice and application, the processing feasibility is taken as a prerequisite and the input of large amount of effort is required, such that the results of topology optimization can be used as a reference design for re-designing the profile of mechanical structure.

Among the structural topology optimization methods currently developed in academic circles, the solid isotropic material with penalization (SIMP) method and the bi-directional evolutionary structural optimization (BESO) method are relatively matured methods. The concept of the SIMP method is as follows. After the design space is divided to form a finite element model, the density of each element is used as a numerical optimization design variable. Then, finite element analysis (FEA) is performed to obtain a physical quantity, such as the strain energy of each element, for calculating the sensitivity of numerical optimization, and the correction direction for the density of each element is found by using the numerical optimization method, such that the target function of optimization and restriction condition can be satisfied. The disadvantage of the SIMP method lies in that the structural profile is represented by using grayscale element instead of directly removing elements from the model, so that the user cannot easily judge the results. Instead of finding the optimization direction by using the numerical optimization method, the BESO method directly determines whether an element should be retained or removed according to the magnitude of the strain energy of each element, and such determination is relatively easier. However, the BESO method is disadvantaged in that after the structural volume capacity reaches the initial limit of volume capacity, the iteration process still repeats until the target function (total structural strain energy) converges. Since the iteration process is repeated too many times, the computing time cannot be reduced.

Therefore, given that processing feasibility is taken as a pre-requisite, how to provide a structural topology optimization design method more conformed to engineering practice and application is more important than obtaining actual structural profile by using existing structural topology optimization computing methods.

### SUMMARY

The disclosure is directed to a structural topology optimization design method based on the bi-directional evolutionary structural optimization (BESO), but omits the step of repeating the iteration process until the target function converges after the target volume capacity is reached, and directly regards the structural profile recorded after each loop was completed as an optimization result corresponding to the target volume capacity. The structural profiles obtained after each loop was completed can form a set of sequential optimization structures with different volume capacities. As the volume capacity varies, various structures with different arrangements of ribbed plate and rods are formed. The contribution to structural stiffness by each ribbed plate and rod can be definitively assessed with a careful check of the relationship diagram of volume capacity vs stiffness in conjunction with accompanying structural profile.

According to one embodiment, a structural topology optimization design method is provided. By observing the structural profile and the relationship diagram of volume capacity percentage vs stiffness percentage sequentially shown on the display interface and checking the processing feasibility, the user can easily determine the design of structural profile conformed to the processing conditions.

According to another embodiment, a structural topology optimization design method is provided. The design method comprises following steps. A structural topology optimization question is defined to determine at least one set of load and restriction condition and a parameter of lower limit of volume capacity related to a design space model. The design space model is divided into a plurality of mesh grids for performing finite element analysis (FEA). Strain energy of each element after FEA is obtained according to the established load and restriction condition and used as a basis for calculating sensitivity of each element. A part of elements is removed or retained according to the degree of sensitivity of each element, and the structural profile and the total volume capacity and total strain energy of residual elements of the structural profile are recorded after each loop was completed. Whether the total volume capacity of residual elements at each loop is greater than an established lower limit of volume capacity or not is determined. If yes, the method returns to the FEA step and continues the iteration process; otherwise, the current loop terminates. A display interface is used to sequentially show the structural profile and a relationship diagram of structural volume capacity vs structural strain energy of the structural profile recorded after each loop was completed.

According to an alternate embodiment, a structural topology optimization design method is provided. the method is based on the bi-directional evolutionary structural optimization (BESO) method but omits the step of repeating the iteration process until the target function converges after the target volume capacity is reached, and directly regards the structural profile recorded after each loop was completed as an optimization result corresponding to the target volume capacity, and uses a display interface to sequentially show the structural profile and a relationship diagram of structural volume capacity vs structural strain energy of the structural profile recorded after each loop was completed.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flowchart of a structural topology optimization design method according to an embodiment of the disclosure.

FIG. 2 is a design space model of machine tool.

FIG. 3 is a design space divided into a finite element model.

FIG. 4 is a diagram of strain energy when the finite element model receives a force.

FIGS. 5˜8 are display interfaces showing the post-processing results.

FIG. 9A is a structure of machine tool conformed to processing feasibility.

FIG. 9B is a cross-sectional view along a cross-sectional line I-I of the machine tool of FIG. 9A.

FIG. 10A is a structure of the machine tool adopting the structural topology optimization version of design of the present disclosure.

FIG. 10B is a structure of the machine tool adopting the original version of design.

FIGS. 11A and 11B show a comparison between the optimization version and the original version of design.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A structural topology optimization design method is provided in an embodiment of the present disclosure. According to current engineering practice, the result of structural topology optimization is merely used as a design reference. In regards of structural properties obtained from calculation, such as structural strain energy and volume capacity, the user can judge the efficiency of optimization result (such as the arrangement of ribbed plates and rods) in structural support by using ‘qualitative’ ratio relationship alone without employing accurate ‘quantitative’ measurements.

Since the optimization result is merely used as a design reference, the user will have more information for making design judgment if ‘multiple’ reference versions are available and the differences of structural properties between multiple reference versions are known. The user can understand better the contribution to structural stiffness made by each ribbed plate and rod of each part of the structure. The user can also know whether the structural stiffness of the structure will deteriorate or collapse if the ribbed plates or rods in some part of the structure are omitted due to the consideration of processing feasibility or cost.

A number of embodiments are disclosed below for detailed descriptions of the disclosure. Based on the bi-directional evolutionary structural optimization (BESO) method, the embodiments of the disclosure provide a practical auxiliary tool for structural design. However, the embodiments below are for exemplary and explanatory purposes only, not for limiting the scope of protection of the disclosure.

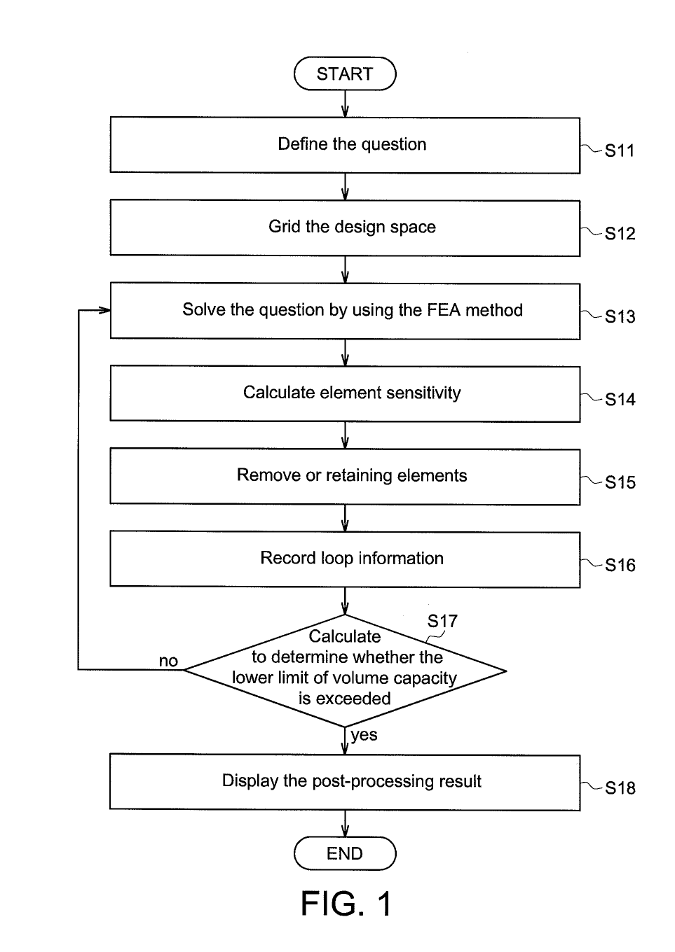

Referring to FIG. 1, a flowchart of a structural topology optimization design method according to an embodiment of the present disclosure is shown.

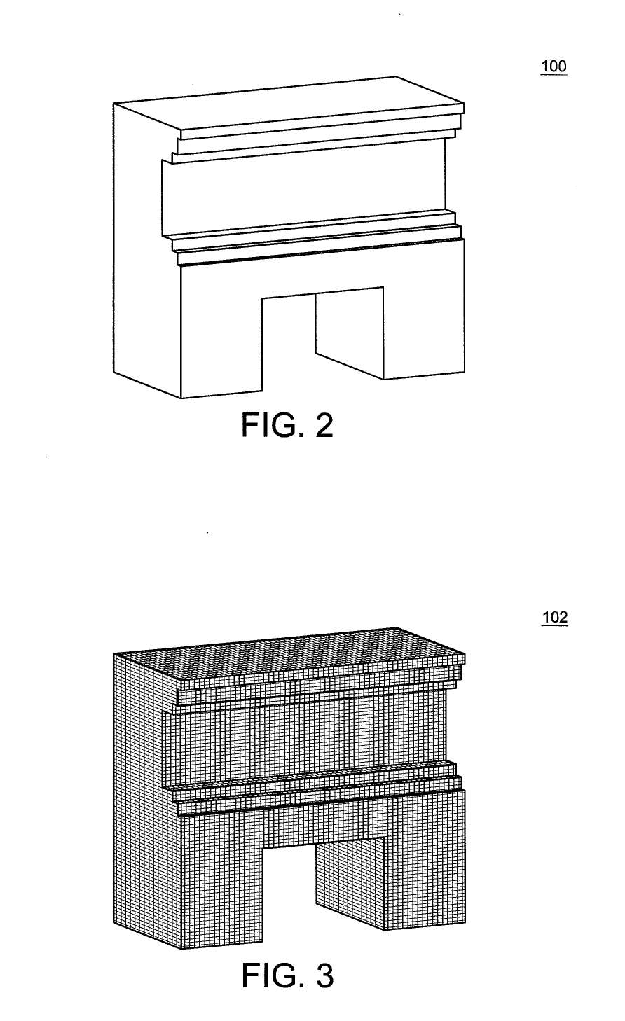

Step S11: defining a question. Firstly, a design space model 100, at least one set of load and restriction condition, an optimization question, and a parameter of the optimization question are defined. The design space, which can be a 2D space or a 3D space, refers to all space in which a structure material space can be disposed without interfering with other components. According to the definition of design space of column structure of a machine tool as indicated in FIG. 2, the space of the original version of design disposed with ribs is now filled up and becomes a solid structure and defined as a design space. The load and restriction condition are applied on the design space model 100 for simulating the stress state of the structure.

The optimization question, such as the minimization of structural strain energy, the minimization of structural deformation or other questions relating to optimization design, is for optimizing the efficiency of material usage of the structural profile. The parameters of optimization question comprise a lower limit of volume capacity and a parameter controlling the removal of materials. The lower limit of volume capacity can also be defined as a lower limit of mass. The material usage of design space varies between complete fill-up and the lower limit of volume capacity. The parameter controlling the removal of materials is determined according to the strategy of removing materials, such as a fixed rate of the removal of materials or other adaptive strategy of removing materials.

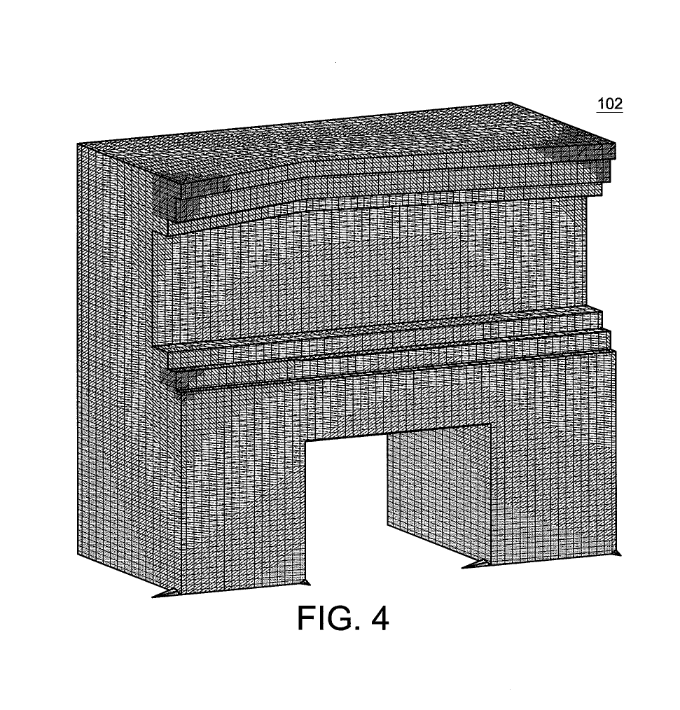

Step S12: gridding a design space. As indicated in FIG. 3, the design space is divided to form a finite element model 102 for performing finite element analysis (FEA).

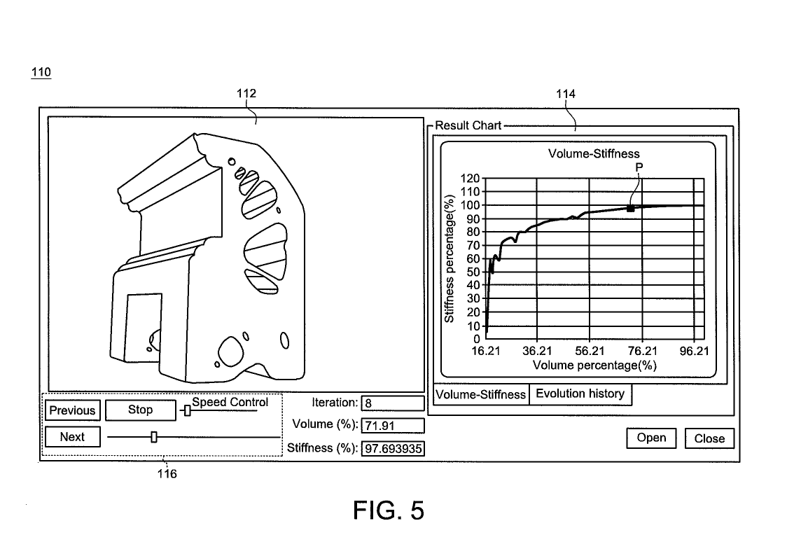

Step S13: solving the question by using the FEA method. As indicated in FIG. 4, information such as displacement of each element under the load and restriction condition defined by the design space is calculated by using the finite element method to obtain the strain energy of each element.

Step S14: calculating element sensitivity. In an embodiment, the optimization question for minimizing the strain energy is taken for example. The sensitivity of an element is regarded as the strain energy of the element. The strain energy of each element can be obtained according to the result of FEA and used as a basis for calculating sensitivity of each element. The sensitivity of an element can be corrected by various generally known technologies, such as the minimal dimension control, the draft direction control and/or the processing direction restriction.

Step S15: removing or retaining elements. Based on the degree of sensitivity of each element, elements with lower degree of sensitivity are removed and elements with higher degree of sensitivity are retained. The number of elements to be removed depends on the technology employed. According to the simplest method, a fixed percentage of volume capacity of elements is removed at each loop. According to complicated removal methods, the number of elements to be removed depends on various adaptive strategies employed in generally known technologies. For example, the volume capacity of element that should be removed at the current loop is determined according to the magnitude of target function variation between previous loop and current loop.

Step S16: recording loop information. After each loop was completed, the structural profile and the total volume capacity and total strain energy of residual elements of the structural profile are recorded to obtain information, such as the structural profile and the structural deformation and structural strain energy (stiffness) of the structural profile, after the elements were removed.

Step S17: calculating to determine whether the lower limit of volume capacity is exceeded. Whether the total volume capacity of residual elements at each loop is greater than an initially established lower limit of volume capacity is determined. If the remaining volume capacity of the current structure is greater than the initially established lower limit of volume capacity, the method returns to the FEA step and continues the iteration process. If the remaining volume capacity of the current structure is less than or equal to the initially established lower limit of volume capacity, the method directly terminates the current loop.

In step S17, the step “repeating the iteration process until the target function converges after the target volume capacity is reached” of the BESO method is omitted, and the structural profile after each loop was completed is directly regarded as an optimization result corresponding to the target volume capacity. In the light of engineering practice, the result of structural topology optimization is only used as a design reference. Therefore, the reduction in computing error reached when the target function converges can be neglected, and the iteration step of the BESO method can be omitted to reduce the computing time. In comparison to the conventional BESO method, the technology of the present disclosure not only reduces the computing time but also allows the user to easily determine the design of structural profile conformed to the processing conditions by observing the structural profile and the relationship diagram of volume capacity percentage vs stiffness percentage sequentially shown on the display interface.

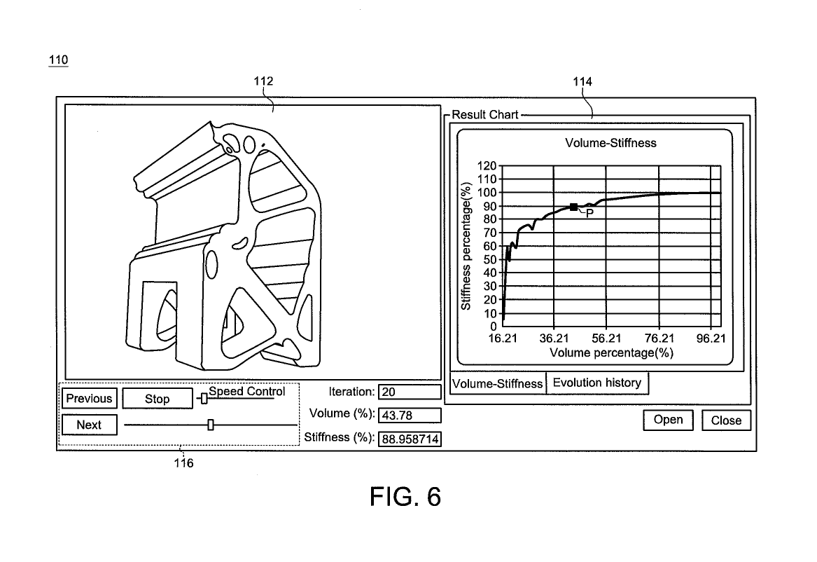

Step S18: displaying the post-processing result. As indicated in FIGS. 5˜8, a display interface 110 sequentially shows the structural profile recorded after each loop was completed and a relationship diagram 114 of structural volume capacity vs structural strain energy of the structural profile. Since the information recorded after each loop was completed needs to be shown on the display interface 110, the display interface 110 may comprise three objects, namely, (1) a display frame 112 of the structural profile, (2) a relationship diagram 114 of structural volume capacity vs stiffness and (3) a loop control panel 116. The display frame 112 of the structural profile can be a 2D or a 3D space display frame. Through the calculation of steps S13˜S16, the structural profile recorded after each loop was completed can be shown on the display frame 112. The relationship diagram 114 of structural volume capacity vs stiffness shows the relationship between the volume capacity percentage and the stiffness percentage of the structure. The quotient of dividing the structural volume capacity recorded after at each loop by the structural volume capacity at the 0-th loop is converted into percentage. Similarly, the quotient of dividing structural strain energy recorded after at each loop was completed by the structural strain energy at the 0-th loop is converted into percentage. The above two percentages are expressed in a 2D coordinate diagram to show relative relationship between the structural volume capacity and the structural strain energy (stiffness). The relationship diagram 114 only shows qualitative relationship between the structural volume capacity and the structural stiffness. However, the above qualitative relationship, despite lacking accurate quantitative measurements, is sufficient for the user to make design judgment.

As indicated in FIGS. 5˜8, the display frame of the relationship diagram 114 has a punctuation P denoting corresponding position of the structural profile of the current display frame 112 in the relationship diagram 114 for the user to better understand the efficiency of material usage of the structural profile.

The loop control panel 116 can be operated by the user. For example, the user can press a runner with a mouse and further move the runner along a slide bar to adjust the loop number (iteration number) and corresponding structural profile shown on the display frame 112; or, the user can press a “play/pause” key to activate an automatic play which plays sequential structural profiles by way of animation. Moreover, the position denoted by the punctuation P of the relationship diagram 114 of structural volume capacity vs stiffness may vary with the operation of the loop control panel 116. Therefore, as the volume capacity varies, various structures with different arrangements of ribbed plate and rods are presented. The contribution to structural stiffness by each ribbed plate and rod can be definitively assessed with a careful check of the relationship diagram 114 of volume capacity vs stiffness in conjunction with accompanying structural profile.

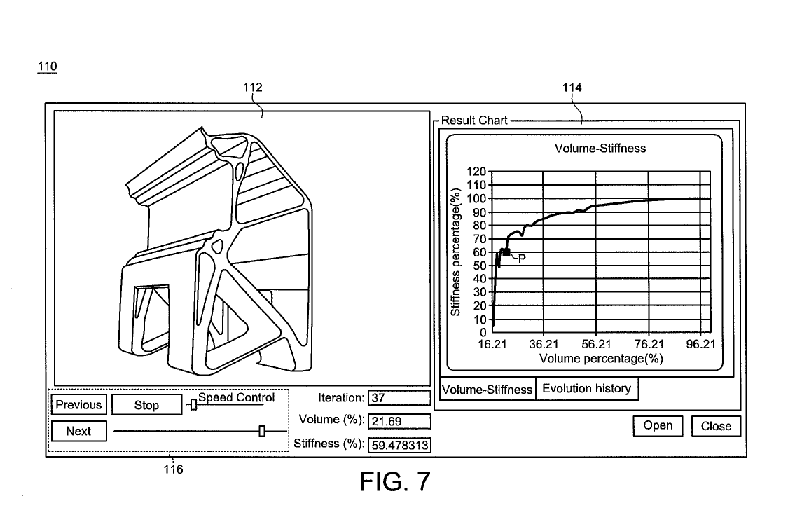

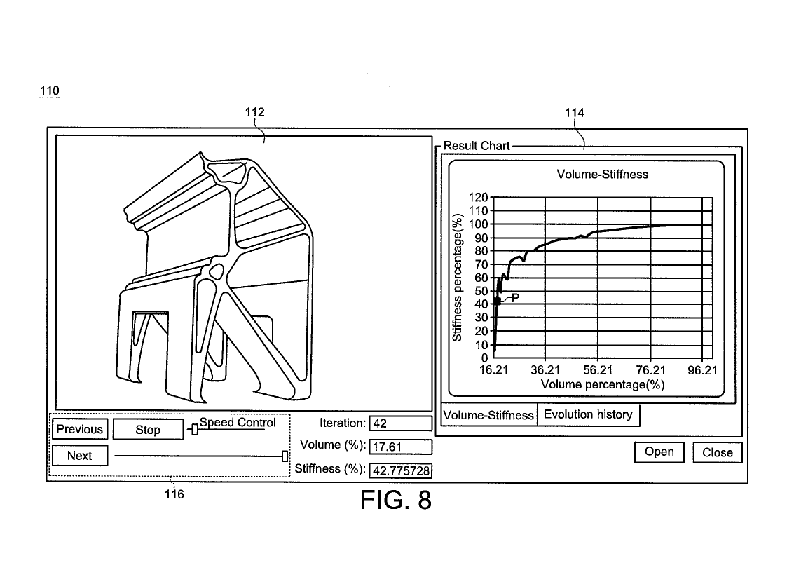

As indicated in FIGS. 5˜8, through the operation of the loop control panel 116, sequential changes in structural profile and the volume capacity and stiffness of the structural profile can be shown. Of the sequential changes in the structural profile, the decrease in the number of ribbed plates in conjunction with corresponding volume capacity percentage and stiffness percentage show the efficiency of material usage and a decreasing trend in the stiffness of the optimization structure. The user, according to his/her experience in the processing practice, can work out with a compromised design based on the concept of optimization structure and conformed to processing feasibility as indicated in FIGS. 9A and 9B. FIG. 9A is a structure of a machine tool 104 conformed to processing feasibility. FIG. 9B is a cross-sectional view along a cross-sectional line I-I of an optimization structure adopting the concepts of the design method of the disclosure. The foregoing design which combines theory and practice shows the effect and design features of the technology of the present disclosure and allows the user to easily determine a structural profile conformed to the processing conditions.

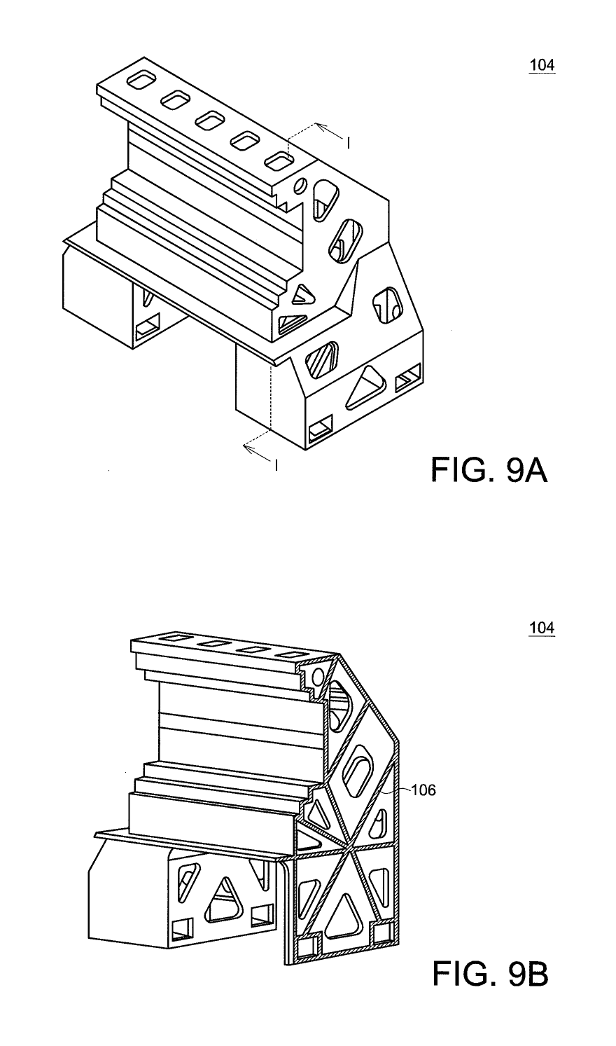

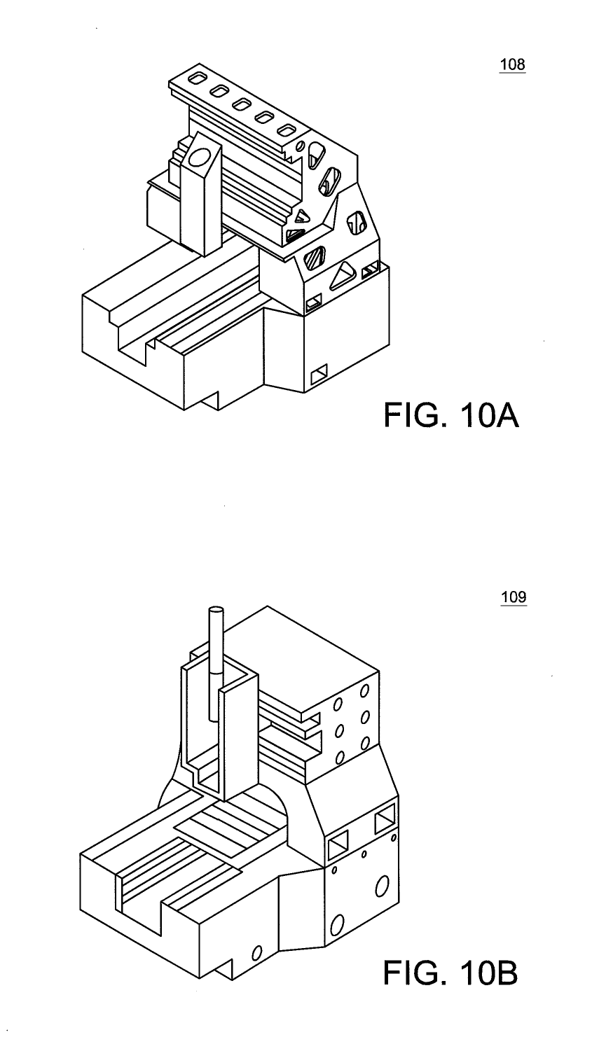

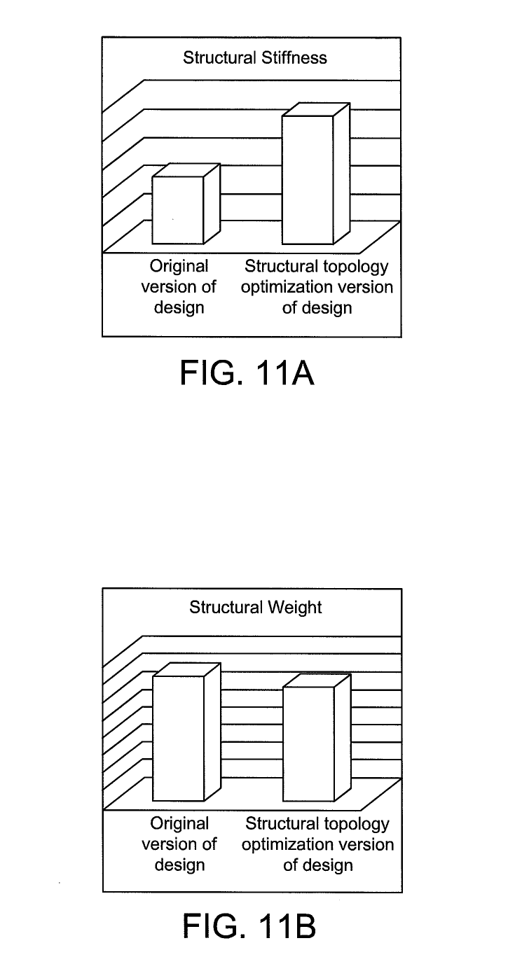

The structural topology optimization design method disclosed in above embodiments of the disclosure is capable of re-designing the structure of other casting pieces of the machine tool, assembling the structure of each casting piece and comparing the structural topology optimization version of design with the original version of design. Refer to FIGS. 10A and 10B. FIG. 10A is a structure of a machine tool 108 adopting the structural topology optimization version of design of the disclosure. FIG. 10B is a structure of a machine tool 109 adopting the original version of design. A comparison between the optimization version and the original version of design is illustrated in FIGS. 11A and 11B. In comparison to the structure adopting the original version of design, the structure adopting the structural topology optimization version of design of the disclosure reduces the weight by 15% and increases the stiffness by 88%. The comparison shows that the effect of the structural topology optimization design method of the disclosure is very significant.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A structural topology optimization design method, comprising:
defining a structural topology optimization question to determine at least one set of load and restriction condition and a parameter of lower limit of volume capacity related to a design space model;
dividing the design space model into a plurality of mesh grids for performing finite element analysis (FEA);
obtaining strain energy of each element after FEA according to the load and restriction condition and using the strain energy as a basis for calculating sensitivity of each element;
removing or retaining a part of elements according to the degree of sensitivity of each element, and recording the structural profile and the total volume capacity and total strain energy of residual elements of the structural profile after each loop was completed;
determining whether the total volume capacity of residual elements at each loop is greater than the lower limit of volume capacity or not: if yes, the method returns to the FEA step and continues iteration process; otherwise, the current loop terminates; and
using a display interface to sequentially show the structural profile and a relationship diagram of structural volume capacity vs structural strain energy of the structural profile recorded after each loop was completed.

2. The design method according to claim 1, wherein the structural topology optimization question is defined as: the efficiency of material usage of the structural profile is optimized when structural strain energy is minimized.

3. The design method according to claim 1, wherein the structural topology optimization question is defined as: the efficiency of material usage of the structural profile is optimized when structural deformation is minimized.

4. The design method according to claim 1, wherein the design space model is a 2D or a 3D space model.

5. The design method according to claim 1, wherein after the strain energy of each element was obtained, the sensitivity of each element is corrected according to a limit of minimal size and/or a limit of processing direction.

6. The design method according to claim 1, wherein after each loop was completed, a fixed percentage of volume capacity of elements is removed from the design space model.

7. The design method according to claim 1, wherein, the volume capacity of elements that should be removed from current loop is determined according to a magnitude of target function variation between previous loop and the current loop.

8. The design method according to claim 1, wherein the display interface comprises a display frame of the structural profile used for representing the structural profile recorded after each loop was completed.

9. The design method according to claim 8, wherein the display interface further comprises a loop control panel used for controlling the display frame to sequentially show the structural profile recorded after each loop was completed.

10. The design method according to claim 9, wherein the display interface further comprises a relationship diagram of structural volume capacity vs stiffness, in which quotient of dividing the structural volume capacity recorded after each loop was completed by the volume capacity initially established at the 0-th loop is converted into percentage denoted on the horizontal axis of the relationship diagram; quotient of dividing the structural strain energy recorded after each loop was completed by the strain energy initially established at the 0-th loop is converted into percentage denoted on the vertical axis of the relationship diagram, and the diagram is represented by way of 2D plane coordinates.

11. The design method according to claim 8, wherein the display interface further comprises a relationship diagram of structural volume capacity vs stiffness, in which quotient of dividing the structural volume capacity recorded after each loop was completed by the volume capacity initially established at the 0-th loop is converted into percentage denoted on the horizontal axis of the relationship diagram, and quotient of dividing the structural strain energy recorded after each loop was completed by the strain energy initially established at the 0-th loop is converted into percentage denoted on the vertical axis of the relationship diagram, and the diagram is represented by way of 2D plane coordinates.

12. The design method according to claim 9, wherein the loop control panel is controlled by a mouse and shows the structural profile recorded at a particular loop on current display frame for a user to view.

13. The design method according to claim 9, wherein the display frame of the structural profile is automatically played by way of animation to sequentially show the structural profile recorded after each loop was completed.

14. The design method according to claim 10, wherein the relationship diagram uses a punctuation to denote corresponding position of the structural profile shown on the current display frame.

15. The design method according to claim 8, wherein the display frame of the structural profile is a 2D or a 3D display frame.

16. A structural topology optimization design method, based on a bi-directional evolutionary structural optimization (BESO) method but omits the step of repeating the iteration process until target function converges after a target volume capacity is reached, and directly regards a structural profile recorded after each loop was completed as an optimization result corresponding to the target volume capacity, and uses a display interface to sequentially show the structural profile and a relationship diagram of structural volume capacity vs structural strain energy of the structural profile recorded after each loop was completed.

17. The design method according to claim 16, wherein the display interface comprises a display frame of the structural profile used for representing the structural profile recorded after each loop was completed.

18. The design method according to claim 17, wherein the display interface further comprises a loop control panel used for controlling the display frame to sequentially show the structural profile recorded after each loop was completed.

19. The design method according to claim 18, wherein the display interface further comprises a relationship diagram of structural volume capacity vs stiffness, in which quotient of dividing the structural volume capacity recorded after each loop was completed by the volume capacity initially established at the 0-th loop is converted into percentage denoted on the horizontal axis of the relationship diagram, and quotient of dividing the structural strain energy recorded after each loop was completed by the strain energy initially established at the 0-th loop is converted into percentage denoted on the vertical axis of the relationship diagram, and the diagram is represented by way of 2D plane coordinates.

20. The design method according to claim 19, wherein the relationship diagram uses a punctuation to denote corresponding position of the structural profile shown on the current display frame.
